(19) United States
(12) Patent Application Publication
(10) Pub. No.: US 2006/0089917 A1
(43) Pub. Date: Apr. 27, 2006

(54) License synchronization

(75) Inventors: Clifford Paul Strom, Sammamish, WA (US); Benjamin Brooks Cutter JR., Kirkland, WA (US); Brian Patrick Evans, Redmond, WA (US); Christopher John Fox, Woodinville, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 10/971,346

(22) Filed: Oct. 22, 2004

(51) Int. Cl. G06Q 99/00; H04L 9/00; H04K 1/00

(52) U.S. Cl. 705/59

(57) ABSTRACT

A method of synchronizing. A method of synchronizing comprising, transferring at least one license of a plurality of licenses from a first PC, populating a license store on a CE device with the at least one license of the plurality of licenses from the first PC, populating a synchronization list with all licenses having state, filtering the synchronization list according to at least one threshold value to create a filtered synchronization list of licenses to be refreshed and refreshing the licenses to be refreshed.

### BACKGROUND

This application relates generally to consumer electronic devices and more specifically to the management of licenses that control media playback on consumer electronic devices.

Electronics may be designed to play or process content that is regulated. Such content may be stored as a file. The content may be controlled or owned by a third party that allows limited access to the content. Examples of limitation include a predetermined number of accesses, or access only over a given time period. A common way of controlling access is through licensing or metering. Control of access is typically provided with security features coupled to the license that may be associated with each file, to restrict access to the content and to regulate play back of the content by the user holding the license.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present invention provides a method of refreshing a group of licenses that may soon expire, or have expired. A synchronization list can be created to aid in refreshing the licenses. Refreshing typically does not call for the transfer of media files along with the refreshed license. The synchronization list can be examined to determine which licenses meet threshold criteria for renewal. These licenses can be added to a filtered sync list that may be used to refresh the selected licenses.

Many of the attendant features of this invention will be more readily appreciated as the same becomes better understood by reference to the following detailed description considered in connection with the accompanying drawings.

### DESCRIPTION OF THE DRAWINGS

These and other features and advantages of the present invention will be better understood from the following detailed description read in light of the accompanying drawings, wherein:

FIG. 1 illustrates a plurality of licenses conventionally stored on a CE device.

FIG. 2 is a diagram of a digital rights management system including license synchronization.

FIG. 3 is a block diagram showing a system for license synchronization.

FIG. 4 is a block diagram showing a process of refreshing licenses by using a sync list.

FIG. 5 is a block diagram showing a process of creating a sync list used in the process of license synchronization.

FIG. 6 is a block diagram showing a process of license refreshing used in the process of license synchronization.

FIG. 7 illustrates an exemplary computing environment in which the systems and methods described in this application, may be implemented.

Like reference numerals are used to designate like parts in the accompanying drawings.

### DETAILED DESCRIPTION

The detailed description provided below in connection with the appended drawings is intended as a description of the present examples of the invention and is not intended to represent the only forms in which the present invention may be constructed or utilized. The description sets forth the functions of the invention and the sequence of steps for constructing and operating the invention in connection with the examples illustrated. However, the same or equivalent functions and sequences may be accomplished by different examples of the invention.

Although the present invention is described and illustrated herein as being implemented in a consumer electronics (“CE”) device system, the system described is provided as an example and not a limitation. CE devices may include pocket PCs, set top boxes, portable media centers, cell phones, music players, PCs, software constructed media players, and the like. These devices are typically configured to operate in a system that includes the internet, PCs and the like to work in conjunction with the CE device to facilitate license and content transfer.

As those skilled in the art will appreciate, the present invention is suitable for application in a variety of different types of systems that operate under a license. A typical licensing system is a digital rights management (“DRM”) system. The use of license synchronization (“license sync”) may be useful in the license management and renewal processes for these types of systems.

Most current DRM solutions rely on unique identification of user devices, such as CE devices. Each license is typically bound to a unique consumer electronics device (or playback device), so the license stored in one CE device typically can not be transferred or used by another device. The licenses are typically stored separately from the content, typically in a dedicated storage area. In a DRM System the content, or files that are desired to be played, can be freely transferred. Transfer is typically over unsecured channels such as the internet. In a DRM system the playback of the content is controlled by a license that may be typically played on a specific CE device. Those skilled in the art will realize that the term “play” as used herein may also be construed to mean consumed, or other terms that indicate that there are limits placed upon accessing the media file governed by the license.

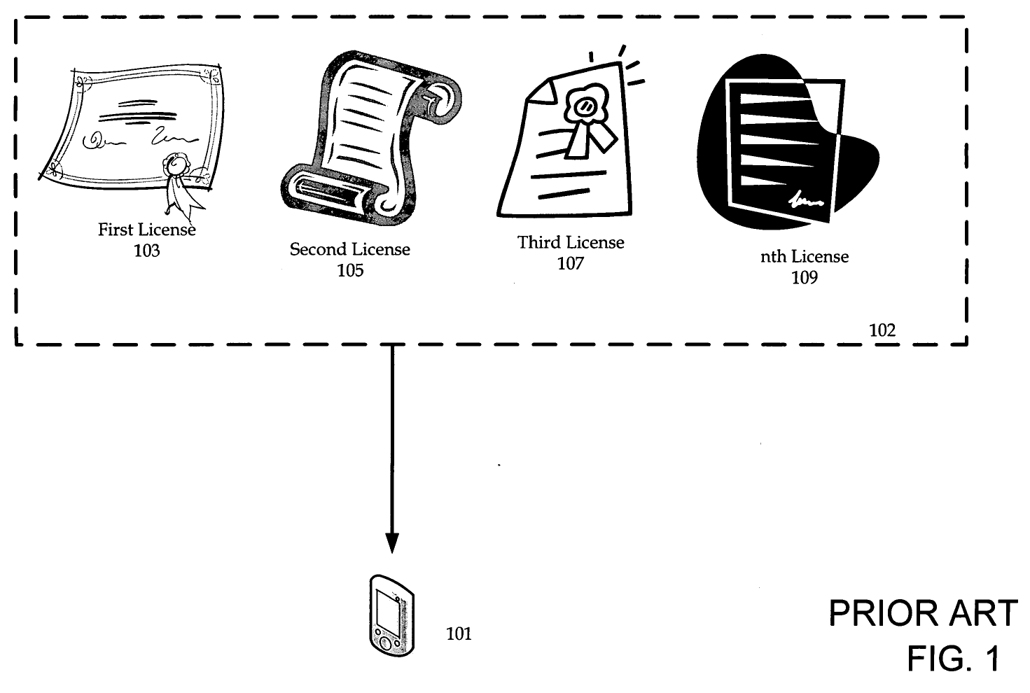

FIG. 1 illustrates a plurality of licenses 102 conventionally stored on a CE device 101. A typical CE device typically stores a plurality of licenses 102. Each license 103, 105, 107, 109 typically accompanies a media file (not shown) that has been downloaded to the CE device 101, typically from a PC (not shown). In the past licenses have been typically downloaded with the content, and not separately. The number of licenses on the CE device 101 can be so large that a user typically can not keep track of the expirations on each of them. The PC will typically contain even more licenses. Occasionally, more than one license will be associated with a media file.

If a user is playing a media file in a system such as shown in the figure and it stops playing due to an expiration date of a license having passed, this detracts from the usability of the CE device. Likewise, if a user attempts to play a file and finds that it will not play because the number of licensed plays allowed has been exceeded, this also detracts from the usability of the device. The user may renew the license to gain access to the media file again (and have to download the content again), but the overall user experience tends to be diminished, since the license conditions are interfering with the user's use of the device to play the content, and the download process for the content is performed again.

A users experience may be improved if soon-to-expire licenses can be managed separately from the content so that their expiration does not tend to interfere with use of the CE device. In such a system licenses may be managed by identifying those that may soon expire and renewing them prior to expiration.

Frequent inability to play licensed content due to license expiration tends to interfere with the desired use of media players, and could hinder acceptance of DRM systems of media playback. The embodiments described typically provide a way to track expired or soon-to-expire licenses, and managing their renewal so that access to content is not disrupted by the expiration of a license. License synchronization aids in creating a DRM system that is invisible to the user. “License synchronization” typically refers to enumerating license entries and collecting lists of those licenses which are expired or approaching expiration. The proximity of expiration may be determined by several conditions including, but not limited to, count and date criteria. License synchronization typically allows license expiration to be anticipated and handled without offending the user's experience with interruptions in service. Application programs can generate a License Synchronization Challenge and refresh licenses prior to expiration.

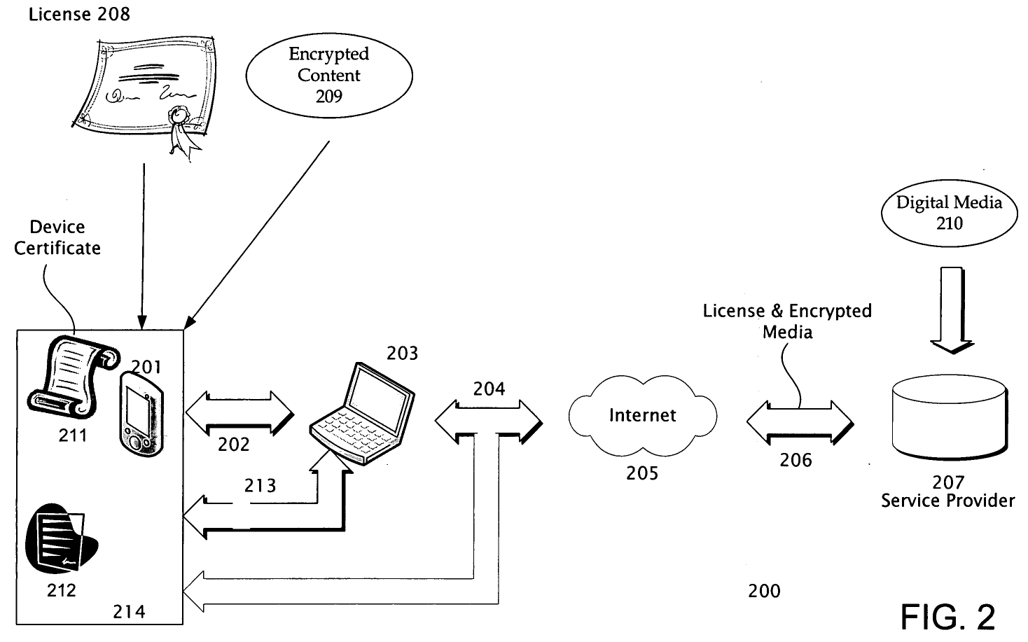

FIG. 2 is a diagram of a digital rights management system 200 including license synchronization. Digital rights management (DRM) provides a system for defining, incorporating, and enforcing rights to digital media 210. A DRM system 200 provides secure distribution of multimedia content 210 from a service provider 207 over insecure channels such as the Internet 205. The system 200 can enforce usage rules and protect the multimedia content 210 from being used illegally. Usage rules can include expiration dates, the number of times a user can play an audio or video file, and the number of times a user can copy an audio or video file and the like. An example of a Digital Rights Management system is provided in U.S. patent application Ser. No. 09/290,363, filed Apr. 12, 1999, U.S. patent applications Ser. Nos. 10/185,527, 10/185,278, and 10/185,511, each filed on Jun. 28, 2002 which are hereby incorporated by reference in its entirety.

A personal computer 203 may be used to connect to the internet 205 and transfer content from the service provider 207 to a consumer electronics device 201. The PC may have a large number of licenses stored on it. The licenses can have unlimited rights, rights to play the file a certain number of times, rights to play the file until a certain date, and the like. Management of the expiring licenses in a way that tends not to interfere with the use of the CE device tends to be provided by the embodiments of the invention.

Protocols for transferring information to the PC 203, and to the CE device 201 over paths 202 and 204 may be achieved by conventional connections such as USB, infrared, Bluetooth, MTP and the like. These pathways may be useful for transmitting licenses and content, including renewing licenses that have expired or are due to expire.

In alternative embodiments a consumer electronics device may be coupled to a service provider without using the personal computer 203. The personal computer and the CE devices may operate utilizing any number of suitable operating systems known to those skilled in the art. The instructions for implementing the functions described in this application may exist as software, hardware (for example instructions burned into an ASIC), or a combination of both.

In typical use, DRM 200 protects contents 210 by providing encrypted data files 209. Since files 209 are encrypted, the data itself is protected. Thus, the files 209 may be moved, archived, copied, or distributed without restriction. There is no need to hide files or make them inaccessible, or to put special protection in place when files are transmitted from system to system. However, copying a file and giving it to a friend will not enable that friend to use the file. In order to be able to use an encrypted file, users must obtain a license 208. This license 208 is a way of exercising control over the encrypted file 210. A license 208 is typically granted to a single machine 201, and even if copied, it will not tend to function on other machines.

Each license 208 contains rights and restrictions, defining how the data in a file may be used, and under what conditions. For example, a music file license may contain a “right to play” but not a “right to burn to CD”, and it might enable these rights for the period between Oct. 1, 2005 and Nov. 1, 2005. It is also possible that there will be multiple licenses for a file. Keeping track of these licenses, and updating them as needed without creating undue burdens on the user may be a challenge in consumer acceptance of DRM systems. As long as one of those licenses grants the needed right, the user will be able to access and use their data. Access may refer to cryptographically decoding a file, gaining access to a file by pass word, and the like so that the consumer electronics device can use, view, play and otherwise use the content of the file.

In the embodiments of the invention described the license 208 works in conjunction with a device certificate 211 that allows the encrypted content 209 to be played on a consumer electronics device 201. The file can also be viewed if the CE device provides video, or picture capabilities. Files for viewing or playback would typically include music files, picture files, video files, documents, and other protected content; in short anything that a service provider wishes to transmit securely over an unsecured channel.

The embodiments may provide license synchronization, which is a process of enumerating a store of license entries, and collecting lists of those which are expired or which are approaching expiration. License synchronization tends to allow license expiration to be anticipated and handled in a manner which does not degrade the user experience with interruptions in service.

Upon acquisition of a new license a license synchronization store may be created. This can be a hashed data store with slots identified by a single key, under which is inserted the data describing a license's expiration criteria. Synchronization-specific data from the license is typically not needed in the license synchronization store.

Synchronization may instead be based on the “license state” as described in the license's data structure. License expiration criteria may be defined by several possible values (e.g. license expiration based on count, date, play count, etc.). Applications may generate a challenge to refresh licenses prior to expiration.

Consumer electronic devices 201 that regulate playback may be referred to as digital rights management (“DRM”) devices. Such devices may be part of a DRM system 200 that controls the distribution of protected content 209 and access to that content 210.

In the example provided a synchronization list (“sync list”) 212 of licenses having state may be kept on the CE device 214. The sync list may include licenses that may be used up or may expire. For example licenses having play counts or any feature which can render the license inactive. The sync list 212 is typically populated at the time that the content 209 is transferred to the device. At time of transfer the key ID for the license and other information may be transferred to the sync list 212. The sync list 212 tends to keep track of licenses that a user may wish to renew, are due for renewal, or will be due for renewal as defined by threshold criteria that may be set. The renewal criteria may be kept on the sync list 212 without having to refer back to the licenses. Likewise play counts may be maintained on the sync list 212.

The information stored on the sync list 212 may be referred to more generally as Key Identifiers (KIDs), or as content identifiers. The sync list is not necessarily a list of licenses. For example in a chain of licenses that refer to a root license, the KID for the root license is stored on the sync list 212, since all of the licenses in the chain would expire when the root license expires. Chained licenses are typically linked together by common rights management policy. License chaining is described in U.S. patent application number (Attorney docket number 305432.01), filed Apr. 23, 2004, and is incorporated herein by reference.

When the CE device 201 is coupled 113 to the computer 203 the licenses may be refreshed. Typically the PC 203 (or host, server or the like) will call for the sync list. Typically the sync list will be filtered by threshold criteria so that a subset of the licenses will be transferred to the host for renewal. Typically the host determines if there are updated licenses that are based on the sync list and will transfer the updated licensed back to the CE device. Alternatively the CE device may couple directly to the internet 205 to refresh the licenses on the sync list 212.

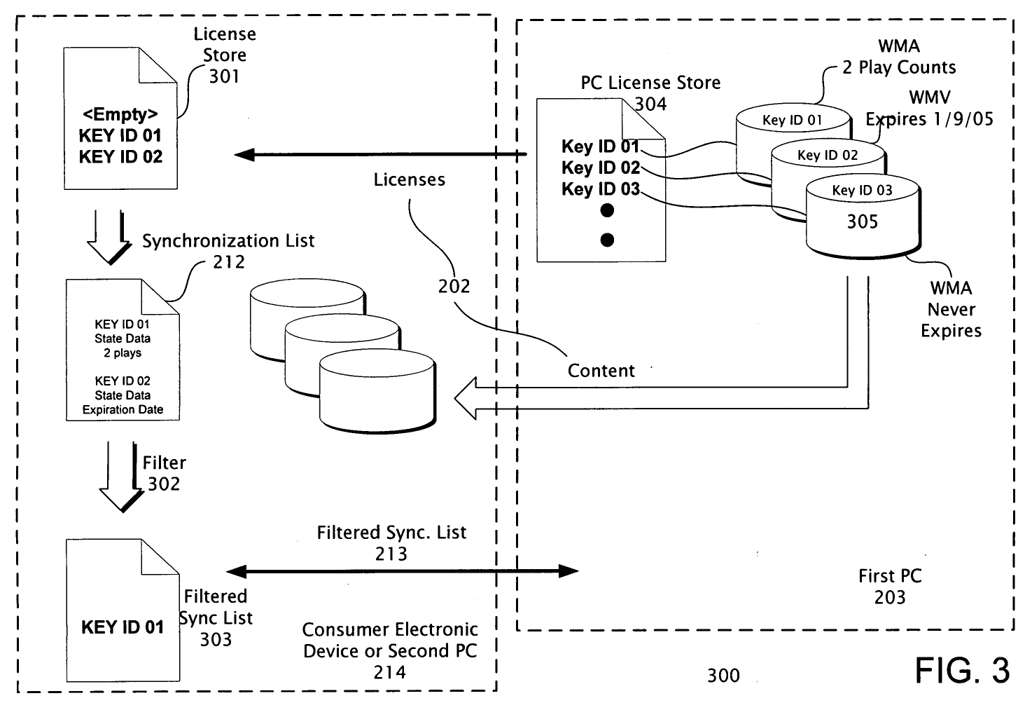

FIG. 3 is a block diagram showing a system for license synchronization. Typically a first PC 203 may be used to synchronize the licenses of a CE device 214. In general the method applies to synchronizing things that are associated with digital media, documents, software subscriptions and the like. In alternative embodiments a second PC may be substituted for the CE device 214. The CE device and first PC may be docked or coupled by any conventional linking method such as USB, Bluetooth, infrared and the like. In alternative embodiments this method may be utilized in client to server applications, CE to CE devices, PC to PC applications, and the like. In the example shown XML lists, or their equivalent, may be used to transfer the various lists between devices, and the device programming may be done in the C programming language or its equivalent.

The first PC 203 typically includes a PC license store 304. The PC license store typically includes a plurality of licenses represented by Key ID 01, Key ID 02, Key ID 03, et. ct. Such license stores can typically include a large number of licenses, for example an entry of over 10,000 licenses may not be considered uncommon.

The first PC 203 typically includes a license store 301 of its own. The licenses contained in license store 301 may be a subset of the licenses from the PC license store 304. Initially license store 301 is empty “<Empty>” when the CE device 214 is docked to the first PC 203. Upon the first synchronization key IDs Key ID 01, Key ID 02, et ct. may be transferred 202 from the PC license store 304 to the License store 301.

A key ID may be approximated as a content ID. For example a plurality of content files 305 may include a WMA content file, a WMV content file, or the like. In this example the WMA content files include a first WMA file that has an exemplary two play counts associated with it, and an exemplary second WMA content file that never expires. The exemplary WMV content file of the plurality of content files expires on Jan. 9, 2004. Remaining play counts, and expiration dates and the like serve as thresholds used in refreshing the licenses downloaded to the CE device. These content files are typically freely transferred 202 from the first PC 203 to the CE device 214. Typically the licenses associated with the content are transferred together 202. In the example shown the license with two play counts and the license with the future expiration date would be transferred to the license store 301, and the content they are tied to would be playable. Because the licenses have expiration criteria associated with them the sync list 212 may be simultaneously populated with this expiration information.

For each content file there is an associated DRM object and contained in that DRM object is the key ID for the content. Each key ID typically points to a license, and multiple content files can point to the same license. An example would be all of the content files that make up an album having the same key ID, associated with a single license. Another example would be individual key IDs pointing to individual licenses.

After the initial transfer of content and licenses 202 to the CE device 214 the user can undock the CE device and proceed to access the files, by playing the music, viewing the video and the like. After the licenses expire the content can no longer be accessed. In the example if the expiration date and the play counts have been exceeded then the content can no longer be played. When the user docks the CE device 214 to the first PC 203 a media player on the pc can be used to sync the licenses between the CE device 214, and the first PC 203. The media player can specify synchronization of licenses that are due to expire within a given time period or have a certain play count remaining or other threshold data. The threshold data from the media player residing in the first PC 203 is sent to the CE device 214. The CE device 214 typically contains its own code base, and the threshold data received from the first PC 203 is compared to the data on the sync list 212 to see if the threshold has been exceeded. The result of the comparison process is to create a filtered sync list 303 of licenses whose state data such as expiration date, or play count exceeds the threshold. The key IDs that make up the filtered list are then transferred back 213 to the first PC 203. The first PC would then typically generate or refresh the appropriate licenses and transmit them back to the CE device 214 so that the content 305 that was previously downloaded to the CE device 214 can be played again. In alternative embodiments memory buffer size limitations may be accommodated by breaking the filtered sync list 303 into smaller numbers of entries and making multiple passes in synchronizing to update all of the licenses on the filtered sync list 303. In further alternative embodiments the sync list 212 may be passed to the first PC 203 and a filtered list may be generated on the first PC 203.

Licenses that never expire may be excluded from the sync list 212 in further alternative embodiments. In further alternative embodiments the licenses that are due to expire may be sent directly to the PC for renewal without utilizing an intermediary sync list.

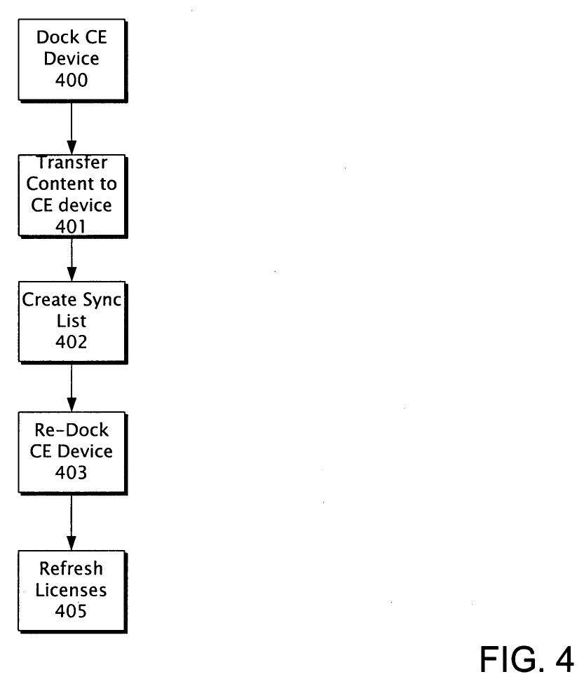

FIG. 4 is a block diagram showing a process of refreshing licenses by using a sync list. At block 400 a CE device is docked to a host such as a PC having a plurality of licenses to be transferred to the CE device. At block 401 items are added to the sync list when content is transferred to the CE device. At block 402 a sync list is created on the CE device, typically while the content is being downloaded to the CE device. The device is typically removed from docking and played for a period of time until it is re-docked. At block 403 the CE device is again docked with the CE device to synchronize its licenses with the PC and refresh expiring licenses. At block 405 the licenses are refreshed, typically by utilizing a filtered sync list. The device application acquires the refreshed licenses while connected, and the sync list is kept current by periodically refreshing it until the next docking.

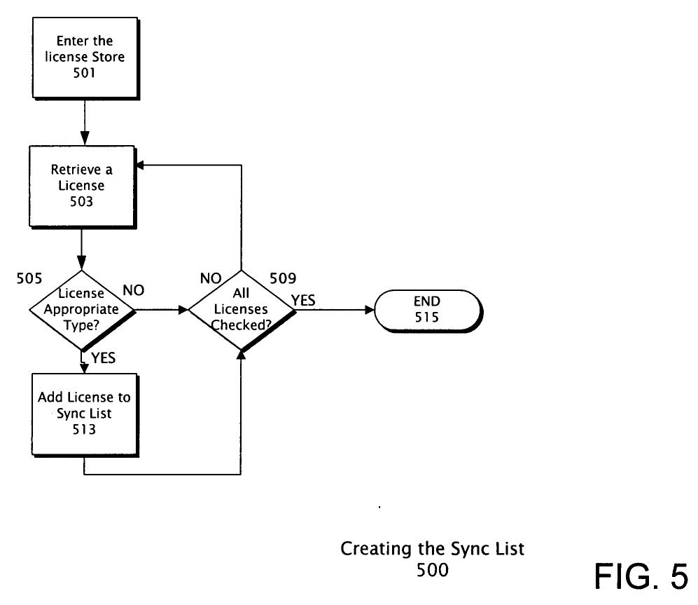

FIG. 5 is a block diagram showing a process of creating a sync list 500 used in the process of license synchronization. At block 501 the license store is entered. At block 503 a license is retrieved, and at block 505 it is examined to determine if the license is the desired type of license. Typically a license of the appropriate type is one having restricted play, and not one having unlimited access. If the license is not of the right type the process returns to block 509 and another license is retrieved. If the license is of the desired type the process proceeds to block 513 where it is added to the sync list.

At block 509 it is determined whether there are any more licenses to be checked. If there are, the process returns to block 503. It there are not any more licenses to be added to the sync list the process ends 515.

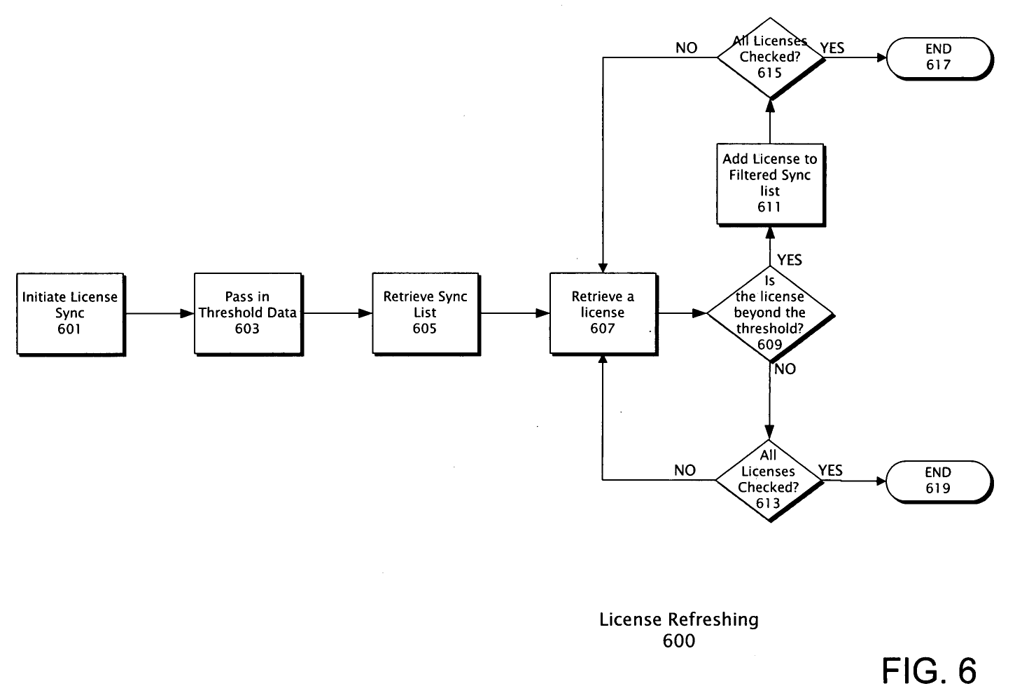

FIG. 6 is a block diagram showing a process of license refreshing 600 used in the process of license synchronization. At block 601 a license synchronization is initiated. At block 603 the threshold data is loaded in to the process. At block 605 the sync list is retrieved, and at block 607 a license is retrieved from the sync list.

At block 609 it is determined if the license is beyond the threshold data that was previously loaded at block 603. If it is the license is added to a filtered sync list at block 611. At block 615 it is determined if all licenses have been checked. If they have not the process returns to block 607. If they all have been checked the process ends at 617.

Returning to block 609, if the license is not beyond the threshold the process proceeds to block 613 where it is determined if all licenses have been checked. If they have not the process returns to block 607. If all the licenses have been checked the process ends at 619.

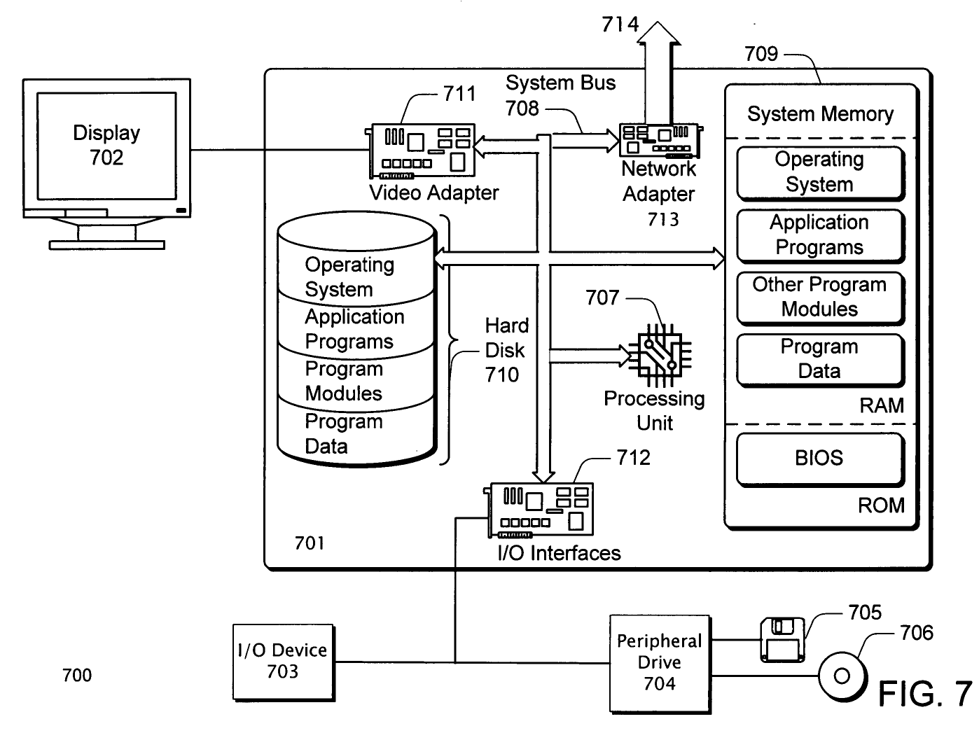

FIG. 7 illustrates an exemplary computing environment 700 in which the systems and methods described in this application, may be implemented. Exemplary computing environment 700 is only one example of a computing system and is not intended to limit the examples described in this application to this particular computing environment.

The computing environment 700 can be implemented with numerous other general purpose or special purpose computing system configurations. Examples of well known computing systems, may include, but are not limited to, personal computers, hand-held or laptop devices, microprocessor-based systems, multiprocessor systems, set top boxes, programmable consumer electronics, gaming consoles, Consumer electronics, cellular telephones, PDAs, and the like.

The computer 700 includes a general-purpose computing system in the form of a computing device 701. The components of computing device 701 can include one or more processors (including CPUs, GPUs, microprocessors and the like) 707, a system memory 709, and a system bus 708 that couples the various system components. Processor 707 processes various computer executable instructions to control the operation of computing device 701 and to communicate with other electronic and computing devices (not shown). The system bus 708 represents any number of several types of bus structures, including a memory bus or memory controller, a peripheral bus, an accelerated graphics port, and a processor or local bus using any of a variety of bus architectures.

The system memory 709 includes computer-readable media in the form of volatile memory, such as random access memory (RAM), and/or non-volatile memory, such as read only memory (ROM). A basic input/output system (BIOS) is stored in ROM. RAM typically contains data and/or program modules that are immediately accessible to and/or presently operated on by one or more of the processors 707.

Mass storage devices 704 may be coupled to the computing device 701 or incorporated into the computing device by coupling to the buss. Such mass storage devices 704 may include a magnetic disk drive which reads from and writes to a removable, non volatile magnetic disk (e.g., a “floppy disk”) 705, or an optical disk drive that reads from and/or writes to a removable, non-volatile optical disk such as a CD ROM or the like 706. Computer readable media 705, 706 typically embody computer readable instructions, data structures, program modules and the like supplied on floppy disks, CDs, portable memory sticks and the like.

Any number of program modules can be stored on the hard disk 710, Mass storage device 704, ROM and/or RAM 709, including by way of example, an operating system, one or more application programs, other program modules, and program data. Each of such operating system, application programs, other program modules and program data (or some combination thereof) may include an embodiment of the systems and methods described herein.

A display device 702 can be connected to the system bus 708 via an interface, such as a video adapter 711. A user can interface with computing device 702 via any number of different input devices 703 such as a keyboard, pointing device, joystick, game pad, serial port, and/or the like. These and other input devices are connected to the processors 707 via input/output interfaces 712 that are coupled to the system bus 708, but may be connected by other interface and bus structures, such as a parallel port, game port, and/or a universal serial bus (USB).

Computing device 700 can operate in a networked environment using connections to one or more remote computers through one or more local area networks (LANs), wide area networks (WANs) and the like. The computing device 701 is connected to a network 714 via a network adapter 713 or alternatively by a modem, DSL, ISDN interface or the like.

Those skilled in the art will realize that storage devices utilized to store program instructions can be distributed across a network. For example a remote computer may store a tool such as the adaptive instrumentation runtime monitoring and analysis software. A local or terminal computer may access the remote computer and download a part or all of the software to run the program. Alternatively the local computer may download pieces of the software as needed, or distributively process by executing some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

The following paragraphs provide an example of license synchronization that may be implemented in C language, and makes use of an XML list. Equivalently other languages and list types may be used instead. When a new license acquired and stored in the license store its KIDs are stored in a synchronization store (“sync store”). Licenses with no limitations are specifically excluded from the sync store, as they will never need to be synchronized. When licenses are deleted their KIDs are removed from the license store. When the license synchronization API is called an XML synchronization challenge is generated and returned to the calling application for use in renewing the licenses.

First a synchronization store is created. The synchronization store may be a hash data storage whose slots are identified by a single key, and under this key are inserted the data describing a license's expiration criteria.

KIDs are inserted into the synchronization store when licenses are acquired. As an example the CE device may receive a license response XML file from a license server, and at this time the KIDs from the license are added to the store. A license may have one KID and different licenses may share the same KID.

There is typically no synchronization specific data included with a license. Synchronization is typically based on the “license state,” as may be described in an exemplary DRM_LICENSE_STATE_DATA data structure. The storage entry consists of the data structure which may be written out as raw binary data.

| typedef struct _DRM_LICENSE_STATE_DATA | |
|---|---|
| { | |
| DRM_DWORD dwStreamId; | |
| DRM_DWORD dwCategory; | |
| DRM_DWORD dwNumCounts; | |
| DRM_DWORD dwCount [4]; | |
| DRM_DWORD dwNumDates; | /* Number of |
| items supplied in dwDate. */ | |
| DRMFILETIME datetime [4]; | /* Up to 4 |
| dates. */ | |
| DRM_DWORD dwVague; | /* 0 -> certain, |
| 1 -> atleast. (There could be more */ | |
| | /* |
| licenses. Aggregation not possible.) | */ |
| } DRM_LICENSE_STATE_DATA; | |

In the example above dwStreamId has nothing to do with license synchronization. The dwCategory indicates the category of string to be displayed. The dwCategory describes the license expiration criteria and can be one of the following values:

| | |
|---|---|
| WM_DRM_LICENSE_STATE_NORIGHT | License has no rights |
| WM_DRM_LICENSE_STATE_UNLIM | Unlimited license |
| WM_DRM_LICENSE_STATE_COUNT | Expiration based on count |
| WM_DRM_LICENSE_STATE_FROM | License enabled after a certain |
| | date |
| WM_DRM_LICENSE_STATE_UNTIL | License enabled until a certain |
| | date |
| WM_DRM_LICENSE_STATE_FROM_UNTIL | License enabled after a certain |
| | date and until a certain date |
| WM_DRM_LICENSE_STATE_COUNT_FROM | License enabled after a certain |
| | date and up to a given number |
| | of play counts |
| WM_DRM_LICENSE_STATE_COUNT_UNTIL | License enabled until a certain |
| | date and up to a given number |
| | of play counts |
| WM_DRM_LICENSE_STATE_COUNT_FROM_UNTIL | License enabled after a certain |
| | date and until a certain date |
| WM_DRM_LICENSE_STATE_EXPIRATION_AFTER_FIRSTUSE | License allows only a single play |
| WM_DRM_LICENSE_STATE_FORCE_SYNC | A special flag that requires the |
| | license store to be read at the |
| | time of generating a sync |
| | challenge |

The dwNumCounts member may describe how many of the four counts in dwCount are actually used. The dwNumDates member describes how many of the four dates in the datetime array are valid. The dwVague member indicates the certainty about the number of licenses that were aggregated to fill in the other members. A value of zero indicates certainty; a value of one may means that there are one or more licenses but the exact number is not determined.

In retrieving the synchronization list in the example shown a synchronization challenge is generated in response to an application call to the solitary synclist API, DRM_SNC_GenerateSyncChallenge. Parameters passed to this call are:

| Parameter Name | Data Type | Description |
|---|---|---|
| f_cMaxCount | DRM_DWORD | Maximum remaining |
| | | play-count of included |
| | | licenses |
| f_cMaxHours | DRM_DWORD | Maximum remaining |
| | | hours before |
| | | expiration of included |
| | | licenses |
| f_iKIDStart | DRM_DWORD | Index in the synclist of |
| | | the first KID to return; |
| | | 0 for the first call and |
| | | a starting index on |
| | | subsequent calls |
| f_cKIDs | DRM_DWORD | Maximum number of |
| | | KIDs to return in the |
| | | sync challenge |
| f_piKIDNext | DRM_DWORD* | Returns index of the |
| | | next KID after the last |
| | | one in the sync |
| | | challenge; returned |
| | | value is placed into |
| | | f_iKIDStart for |
| | | subsequent calls |
| f_pcKIDs | DRM_DWORD* | Returns the number of |
| | | KIDs in the sync |
| | | challenge |
| f_pbChallenge | DRM_BYTE* | Buffer to fill with the |
| | | sync challenge |
| f_pcbChallenge | DRM_DWORD* | On input gives the |
| | | maximum size of the |
| | | challenge buffer; on |
| | | exit returns the |
| | | number of bytes |
| | | actually used |

The first two parameters describe the threshold conditions for the KIDs to return. The maximum number of hours remaining or the maximum number of play counts remaining define which KIDs to include in the challenge XML; in each case a value of 0xFFFFFFFF means to ignore this parameter and return all expiration/play-count licenses respectively. If both threshold parameters are set to 0xFFFFFFFF then all non-unlimited license KIDs are returned.

The next four parameters are used to retrieve the sync challenge in multiple calls. Since the sync store has potential to become very large the generation of a challenge could time out the device; allowing challenges to be generated in multiple requests for subsets ensures that devices can specify a number that can complete in a designated interval. The first parameter in this group specifies a starting zero-based index. The second specifies the number of KIDs to return in the challenge. The third and fourth are out parameters and they respectively return the index of the next KID to request and the number of KIDs returned.

A typical calling sequence is below; values returned are underlined:

f_iKIDStart 0
f_cKIDs 100
f_piKIDNext 100
f_pcKIDs 43
f_iKIDStart 100
f_cKIDs 100
f_piKIDNext 200
f_pcKIDs 51
f_iKIDStart 200
f_cKIDs 100
f_piKIDNext 273
f_pcKIDs 38

Note that in this example a f_piKIDNext value less than the sum of the starting index and the number of KIDs reliably indicates that the search is done; if however the new starting index is equal to this sum there is typically no way other than another call to determine if enumeration is complete.

The final two parameters represent the buffer to write the challenge XML into. The last parameter is used both in and out, holding the maximum size in bytes of the buffer on input and the number of bytes actually used on output.

The synchronization challenge XML in this example has the following form:

```
<DRMSYNCLIST type=“challenge”>
    <RECORDS>
        <KID>UiW5yBMep2CuevGg5+FgA3==</KID>
        <KID>Mep2CuevGgUiW5yB5+FgA3==</KID>
...
    </RECORDS>
</DRMSYNCLIST>
```

In this example it is typically the device application's responsibility to send this XML to a license server and to process its responses as any other license response.

1. A method of synchronizing comprising:
transferring at least one license of a plurality of licenses from a first PC;
populating a license store on a CE device with the at least one license of the plurality of licenses from the first PC;
populating a synchronization list with all licenses having state;
filtering the synchronization list according to at least one threshold value to create a filtered synchronization list of licenses to be refreshed; and
refreshing the licenses to be refreshed.

2. The method of synchronizing of claim 1 in which the synchronization operates in a DRM environment.

3. The method of synchronizing of claim 1 in which the at least one threshold value includes a play count.

4. The method of synchronizing of claim 1 in which the at least one threshold value includes an expiration date.

5. The method of synchronizing of claim 1 in which the at least one threshold value includes a value less than a play count.

6. The method of synchronizing of claim 1 in which the at least one threshold value includes a value in before an expiration date.

7. The method of synchronizing of claim 1 in which the at least one threshold value includes a license state.

8. The method of synchronizing of claim 1 in which the synchronization list is populated at the time content is transferred to the device.

9. The method of synchronizing of claim 1 in which the synchronization list is populated prior to the time content is transferred to the device.

10. The method of synchronizing of claim 1 in which the synchronization list includes renewal criteria.

11. The method of synchronizing of claim 1 in which the synchronization list includes a play count.

12. A method of synchronizing comprising:
transferring at least one license of a plurality of licenses from an internet service provider;
populating a license store on a CE device with the at least one license of the plurality of licenses from the internet service provider;
populating a synchronization list with all licenses having state;
filtering the synchronization list according to at least one threshold value to create a filtered synchronization list of licenses to be refreshed; and
refreshing the licenses to be refreshed.

13. The method of synchronizing of claim 12 in which the synchronization operates in a DRM environment.

14. The method of synchronizing of claim 12 in which the at least one threshold value includes a play count.

15. The method of synchronizing of claim 12 in which the at least one threshold value includes an expiration date.

16. The method of synchronizing of claim 12 in which the at least one threshold value includes a value less than a play count.

17. The method of synchronizing of claim 12 in which the at least one threshold value includes a value in before an expiration date.

18. The method of synchronizing of claim 12 in which the at least one threshold value includes a license state.

19. The method of synchronizing of claim 12 in which the synchronization list is populated at the time content is transferred to the device.

20. The method of synchronizing of claim 12 in which the synchronization list is populated prior to the time content is transferred to the device.

21. The method of synchronizing of claim 12 in which the synchronization list includes renewal criteria.

22. The method of synchronizing of claim 12 in which the synchronization list includes a play count.

23. One or more computer-readable media containing executable instructions that, when executed, perform a method comprising:
transferring at least one license of a plurality of licenses to a CE device;
populating a license store on a CE device with the at least one license of the plurality of licenses transferred to the CE device;
populating a synchronization list with all licenses having state;
filtering the synchronization list according to at least one threshold value to create a filtered synchronization list of licenses to be refreshed; and
refreshing the licenses to be refreshed.
The one or more computer-readable media as recited in claim 23, in which the method further comprises [step C]

24. The method of synchronizing of claim 23 in which the synchronization operates in a DRM environment.

25. The one or more computer-readable media as recited in claim 23, in which the at least one threshold value includes a play count.

26. The one or more computer-readable media as recited in claim 23, in which the at least one threshold value includes an expiration date.

27. The one or more computer-readable media as recited in claim 23, in which the at least one threshold value includes a value less than a play count.

28. The one or more computer-readable media as recited in claim 23, in which the at least one threshold value includes a value in before an expiration date.

29. The one or more computer-readable media as recited in claim 23, in which the at least one threshold value includes a license state.

30. The one or more computer-readable media as recited in claim 23, in which the synchronization list is populated at the time content is transferred to the device.

31. The one or more computer-readable media as recited in claim 23, in which the synchronization list is populated prior to the time content is transferred to the device.

32. The one or more computer-readable media as recited in claim 23, in which the synchronization list includes renewal criteria.

33. The one or more computer-readable media as recited in claim 23, in which the synchronization list includes a play count.

34. A system for refreshing licenses comprising:
a means for populating a synchronization list;
a means for filtering the synchronization list; and
a means for refreshing a license listed on the synchronization list.

35. A DRM system comprising:
a CE device including a synchronization list; and
a service provider coupled to the CE device to provide digital media to the CE device.

36. The DRM system of claim 35, in which the service provider is coupled to the CE device through a computer having an internet connection.

37. The DRM system of claim 35, in which the service provider is coupled to the CE device through an internet connection.

38. The DRM system of claim 35, in which the synchronization list includes at least one of a plurality of licenses to be refreshed.

39. The DRM system of claim 38, in which the synchronization list includes at least one of a plurality of licenses to be refreshed that has been added through a filtering process.
